(19) United States
(12) Patent Application Publication
(10) Pub. No.: US 2010/0011977 A1
(43) Pub. Date: Jan. 21, 2010

(54) DEVICE FOR IMPRINTING THE PERIPHERAL SURFACE OF A CYLINDRICAL WORKPIECE

(75) Inventors: Wilfried Philipp, Kornwestheim (DE); Oliver Nitschke, Eberdingen (DE)

Correspondence Address: Brinks Hofer Gilson & Lione/Ann Arbor, 524 South Main Street, Suite 200, Ann Arbor, MI, 48104, US

(73) Assignee: Tampoprint AG, Korntal-Munchingen (DE)

(21) Appl. No.: 12/504,106

(22) Filed: Jul. 16, 2009

Related U.S. Application Data
(60) Provisional application No. 61/084,781, filed on Jul. 30, 2008.

(30) Foreign Application Priority Data
Jul. 17, 2008 (DE) 10 2008 034 187.8

(51) Int. Cl. B41F 17/08

(52) U.S. Cl. 101/40

(57) ABSTRACT

The disclosure relates to a device for printing on the peripheral surface of cylindrical workpieces, in particular bottle stoppers, using a pad printing process, with a feeding device for the workpieces and with a cliché roller, to which are assigned an inking station, a doctoring station, and a printing station, wherein the printing station features a pad roller that transfers the ink from the cliché roller to the workpieces.

### CROSS-REFERENCE TO RELATED APPLICATIONS

This application claims the benefit of U.S. provisional application Ser. No. 61/084,781, filed on Jul. 30, 2008, and German application Ser. No. 10 2008 034 187.8, filed on Jul. 17, 2008, the contents of which are incorporated herein by reference in their entirety. The disclosures of the above applications are incorporated herein by reference.

### FIELD

The invention relates to a device for printing on the peripheral surface of cylindrical workpieces.

### BACKGROUND

The statements in this section merely provide background information related to the present disclosure and may not constitute prior art.

A printing device of this type is known from FR-A-2,312,373, whereby this printing device features a feed roller that has gripping devices for cylindrical workpieces on its periphery, so that the workpieces can be directed past a printing station using the transport device. A disadvantage is that the workpieces have to be inserted one at a time into the gripping devices. Furthermore, from U.S. Pat. No. 6,220,154 a printing device of this kind is known, in which the cylindrical workpieces are gripped on their front faces, so that their periphery can be printed on. With this kind of device, there is always the danger that the workpieces will not be gripped coaxially, that is eccentrically, and that they will not be completely revolved, which results in misprinting.

### SUMMARY

The present disclosure provides a device that enables effective printing on the peripheral surface of cylindrical workpieces, that is, by means of which there can be printing on the shell of cylindrical workpieces in a simple and quick manner.

In one form, this is inventively attained with a device by means of which a pad printing method can be used to print on the peripheral surface of cylindrical workpieces, in particular bottle closures. The device features a feeding device for the workpieces and a cliché roller that is provided with an inking station, a doctoring station, and a printing station, whereby the printing station features a pad roller that transfers the ink from the cliché roller onto the workpieces.

The inventive device is used particularly for printing on bottle stoppers, in particular bottle stoppers made of plastic, which are steadily replacing cork. These bottle stoppers have an imprint on their periphery which, on the one hand, consists of required information, such as the name of the manufacturing or bottling plant, and on the other hand consists of advertising. These bottle stoppers are sent to a printing station by means of a feeding device, and the peripheral surface is printed on in said printing station. This involves ink being taken by an inking roller from an ink tank and transferred to the cliché roller. The cliché roller is doctored by a doctor blade, and the ink in the recesses of the gravure is drawn out using the pad roller and transferred to the peripheral surface of the workpieces. The workpieces themselves are fed via a feeding device and lie coaxially to the pad roller, which rolls off the periphery of the workpieces. This device has the significant advantage of operating asynchronously, because the printing done on the workpieces takes place without a start or finish. The printed impression on the cliché roller is therefore adjusted exactly to the circumference of the workpiece. For the duration of one revolution of a workpiece, the workpieces lie on the periphery of the pad roller.

A further development provides for a separating device to be installed downstream of the feeding device. Using this separating device, the workpieces in a storage unit are separated, that is, fed with an interval between them to the inking station. This has the advantage of ensuring that the same image is transferred to only one workpiece and does not overlap several workpieces.

In one form, the separating device features a separating wheel, which has at least one carrier for a workpiece on its periphery. By adjusting the rotational speed of said separating wheel, the interval between the individual workpieces can be adjusted. In this way, the interval between individual workpieces can be precisely adjusted to the exact circumference of the workpieces, and in such a way that the interval between the longitudinal axes of the individual workpieces (i.e. not the empty space between them) essentially corresponds to the circumference of the workpieces. The cliché roller can now be manufactured as essentially seamless with the engraving for the image.

In a further development of the present disclosure, a control and guiding device is provided, on which the edge area of the shell of the workpieces bears after they have been separated. The control and guiding device presses the workpieces against the pad roller, so that the workpieces, after leaving the separating device, are transported in a guided manner, meaning that they can no longer move freely. In this way, the distance between the workpieces that was created by the separating device is guaranteed and maintained. Since the periphery of the workpieces, but only the edge areas, comes into contact with the control and guiding device, this does not interfere with the printing. There is no printing on this edge area.

Minimal deformation of the workpieces during printing occurs by the control and guiding device exhibiting a separation to the pad roller, which essentially corresponds to the diameter of a workpiece. This not only achieves more secure transport during printing, it is also ensures that the print image is not distorted.

One form of the present disclosure provides for the control and guiding device to be made of two plates that are arranged parallel to each other, the gap between them being slightly smaller than the length of the workpiece, so that the workpiece can roll off on the plate edges. The plates have a thickness which is just sufficient to securely guide the workpieces without the edge areas of the workpieces being damaged. By changing the distance between the plates, the device can be adjusted for workpieces of different length.

A further development of the present disclosure provides for the cliché roller to be divided in an axial direction. In this case, a cut-off disc that projects above the segments of the roller can be provided between the respective parts or sections of the cliché roller. There can be gaps between the parts of the cliché roller, whereby cut-off discs are provided inside these gaps. There is also the possibility that the cut-off discs abut directly against the sections of the cliché roller.

If the inking station has a separate ink chamber for each cliché roller section, then the cliché roller, i.e., the cliché roller sections, can be inked with different printing inks, whereby each cliché roller section is inked with a different printing ink. Each cliché roller section is assigned a separate doctor blade of the doctoring station.

In order to precisely align the print images on the workpieces, the pad roller(s) is/are and/or the cliché roller and/or the inking station is mounted in a laterally displaceable manner.

Using the inventive device, there can be printing on workpieces according to the pad printing method with up to ten different printing inks in a parallel arrangement. The individual printing inks can be automatically fed to the doctor blade chambers, but they can also be fed in a closed loop, wherein a filter system can be interposed, so that any impurities that enter the printing ink can be filtered out. The inking station, the cliché roller, and the pad roller, together with the control and guide device, are either adjustable or the components are easily replaceable, so that the entire printing device can be adjusted to different diameters and/or lengths. The rollers can be attached to shafts, whereby the shafts are accessible from one side. The workpieces can have a diameter of about 1 mm to about 100 mm. Printing inks can be used which harden with exposure to ultraviolet light, are water-based, solvent-free, or contain solvents. Instead of printing inks, primers, adhesives, or other media can also be applied. The cliché roller can consists of ceramic material or metal, in particular hardened steel. The engraving depth can lie between about 2 μm to about 80 μm. The cliché roller can also be provided with different screen engraving and/or line engraving. The doctor blades are placed in the doctoring station in an individually replaceable manner. A single doctor blade can also be provided for all cliché roller components. The pad roller can feature different Shore hardness, and it can consist of plastic, particularly silicon rubber. The pad roller an also be segmented, that is, assembled from pad roller parts or sections arranged one after the other in an axial direction.

Additional advantages, characteristics, and details of the present disclosure are seen in the sub-claims and in the following description, in which one form is described in detail with reference to the drawings. The characteristics shown in the drawings and mentioned in the description and in the claims can be employed individually or in any combination.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of one form of the inventive device; and

FIG. 2 is a lateral view in the direction of arrow II according to FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

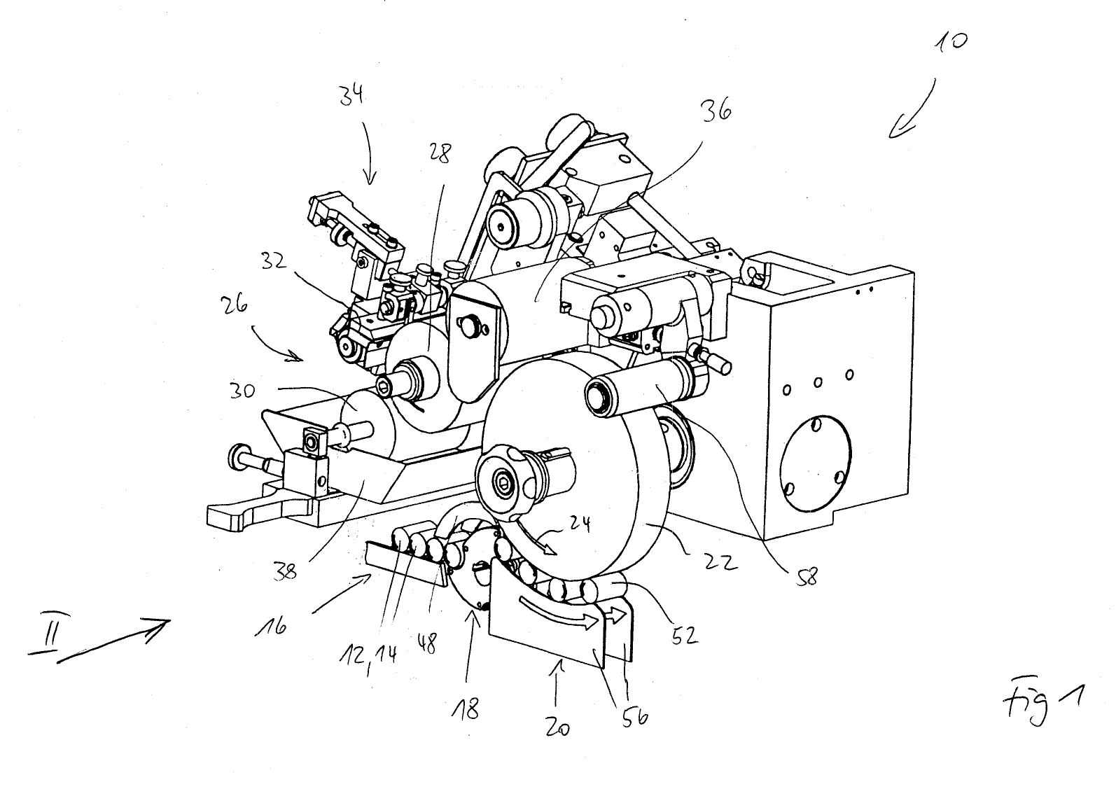

FIG. 1 shows the printing device referred to in its entirety as 10 for printing on workpieces 12, in particular bottle closures 14. The printing device 10 has a feeding device 16, inside which the workpieces 12 are aligned axially parallel to each other and one after the other. A separating device 18 is attached to the feeding device 16, said separating device accepting the foremost workpiece 12 at any given time and feeding it to a control and guiding device 20. This control and guiding device 20 is assigned to a pad roller 22, which rotates in the direction of the arrow 24.

FIG. 1 also depicts an inking station 2, in which a cliché roller 28 is supplied with printing ink. An inking roller 30 abuts on this cliché roller 28, as well as a doctor blade 32 of a doctoring station 34. Above the cliché roller 28 and the pad roller 22, there is an additional means of protection 36, which prevents the two rollers 22 and 28 from engaging.

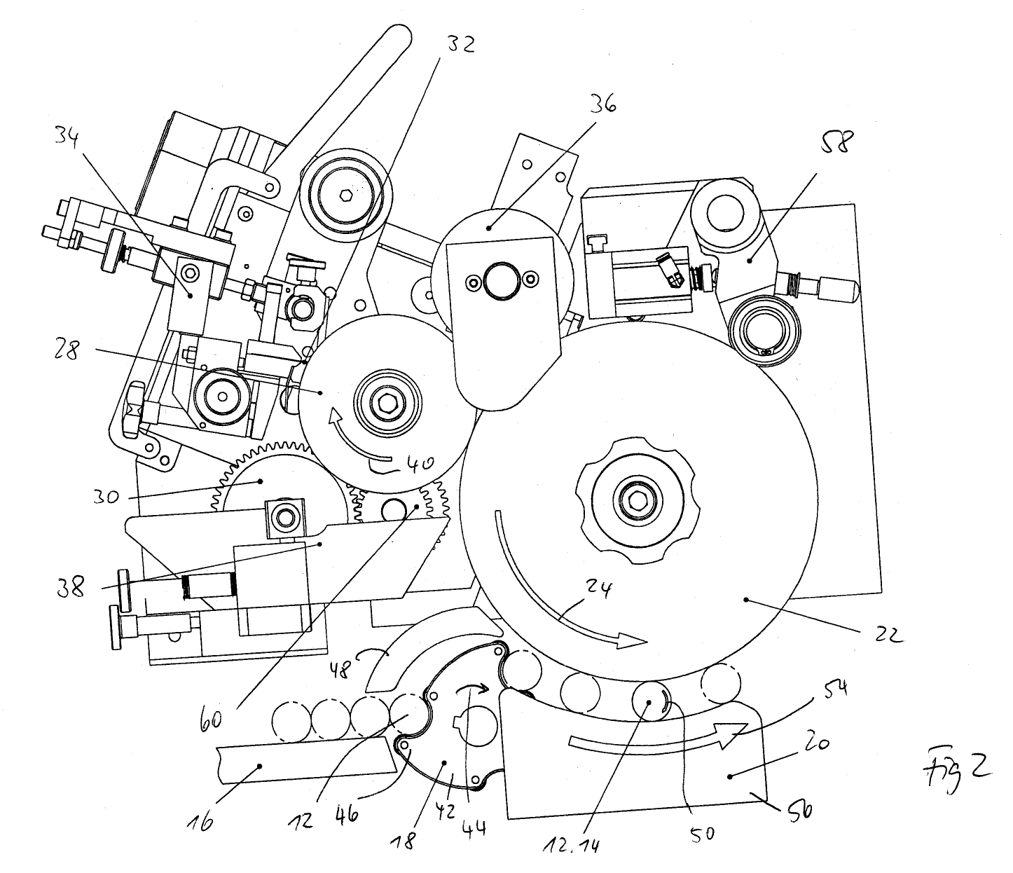

The printing method is described using FIG. 2. In an ink pan 38, there is a printing medium, for example a printing ink, a primer, an adhesive or similar material. This printing medium is drawn up by means of the inking roller, which dips into the ink pan 38 and into the printing medium, and is transferred to the periphery of the cliché roller 28, which rotates in the direction of the arrow 40. Using the doctor blade 32, excess printing medium is scrapped off the surface of the cliché roller 28, so that printing medium remains only in the engraving. This printing medium is taken up by the pad roller 22, which is made of silicon, for example, and rotates in the opposite direction and rolls off the cliché roller 28, and is transported in the direction of the workpieces 12.

These workpieces 12, as mentioned above, are separated by the separating device 18. This separating device 18 has a separating wheel 42, which rotates in the direction of the arrow 44. Three carriers 46 offset by 120°, in one form, are arranged on the separating wheel 42, which grip the foremost workpiece 12 at any given time and transport it along a guideway 48 on which the workpiece 12 rolls and which keeps the workpiece 12 in the carrier 46 in the direction of the pad roller 22.

As can be seen in FIG. 1, the guideway 48 is formed by two plates 56 shaped essentially as segments of a circle. After leaving the guideway 48, the workpieces 12 are transferred to the control and guiding device 20, where they come to a stop after leaving the separating wheel 42, between the control and guiding device 20 and the pad roller 22. The workpieces 12 are transported in a guided manner which means that they are always in a defined position along their transport path. As soon as the workpiece 12 makes contact with the pad roller 22, the workpiece 12 rotates in the direction of the arrow 50, and its periphery surface 52 is printed on by the pad roller 22. After one complete revolution, the workpiece 12 is lifted off the pad roller 22 and falls into a collecting container (not depicted). During rotation, the workpiece 12 is transported along the arrow 54. The workpieces 12 located between the control and guiding device 20 and the pad roller 22 have a mutual separation, that is, the longitudinal axes of the workpieces 12 are so far distant from each other, that this distance corresponds to at least the circumference of a workpiece 12.

As can be seen particularly from FIG. 1, the control and guiding device 20 is formed by two plates 56 which are aligned parallel to each other and at a distance to each other that is smaller than the length of a workpiece 12. The gap between the two plates 56, however, is big enough that the edge areas of the workpieces 12 rest on the edges of the plate 56.

After the printing procedure, any excess printing medium remaining on the pad roller 22 is removed with a unit for removing excess ink 58. Furthermore, any dirt that has been picked up can also be removed with the unit for removing excess ink 58.

The inking roller 30 and the cliché roller 28, the pad roller 22, and the separating device 18 are driven by a drive unit 60.

The ink pan which is depicted as undivided in FIG. 1 can feature several ink chambers arranged side by side for different printing inks, in which case both the inking roller 30 and the cliché roller 28 are divided in the direction of their longitudinal axis into a plurality of roller segments, and wherein each roller segment is inked with a different printing ink. Carryover of ink from one segment of the roller to the other is prevented by cut-off wheels provided between the roller segments. The pad roller 22 can also be constructed of several parts in the direction of its longitudinal axis; but it can also be configured as a one-piece pad roller 22.

Using the inventive printing device, the pad printing process can be used to print on cylindrical workpieces 12, with the possibility of about 100,000 printing operations per hour. The printing can be done in monochrome or polychrome. In addition, the individual rollers are easily replaceable, because their shafts are accessible on one side, so that maintenance and/or repair work can be done quickly. Furthermore, the inventive printing device 10 can be quickly converted for use with workpieces with other diameters and/or other lengths by inserting the appropriate rollers.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A device for printing on the peripheral surfaces of cylindrical workpieces, in particular bottle stoppers, by means of an indirect printing process, in particular a pad printing process, with a feeding device for the workpieces and with a cliché roller to which are assigned an inking station, a doctoring station, and a printing station, wherein the printing station includes a pad roller that applies the ink from the cliché roller to the workpieces.

2. The device according to claim 1, characterized in that a separating device is arranged downstream of the feeding device.

3. The device according to claim 2, characterized in that the separating device features a separating wheel, which on its periphery has at least one carrier for a workpiece, and by means of whose rotational speed the distance between the individual workpieces can be adjusted.

4. The device according to claim 3, characterized in that the distance between the longitudinal axes of single workpieces essentially corresponds to the circumference of a workpiece.

5. The device according to claim 1, characterized in that a control and guiding device is provided, on which the edge areas of the workpieces rest after being separated.

6. The device according to claim 1, characterized in that the control and guiding device is at a distance to the pad roller that essentially corresponds to the diameter of the workpiece.

7. The device according to claim 1, characterized in that the control and guiding device is formed from two plates arranged parallel to each other, the distance between them being slightly shorter than the length of the workpiece, so that the workpiece can roll off on the edges of the plate.

8. The device according to claim 1, characterized in that the cliché roller is divided in an axial direction.

9. The device according to claim 8, characterized in that between each of the respective cliché roller segments, a cut-off wheel is arranged that projects radially above the roller segments.

10. The device according to claim 8, characterized in that the inking station features an ink chamber for each roller segment.

11. The device according to claim 10, characterized in that the ink chambers are combined in an ink pan.

12. A device for printing on the peripheral surfaces of cylindrical workpieces, in particular bottle stoppers, by means of an indirect printing process, in particular a pad printing process, comprising:
a feeding device for the workpieces;
a cliché roller to which are assigned an inking station;
a doctoring station;
a printing station, wherein the printing station includes a pad roller that applies the ink from the cliché roller to the workpieces; and
a separating device that is arranged downstream of the feeding device, wherein the separating device includes a separating wheel, which on its periphery has at least one carrier for a workpiece, and by means of whose rotational speed the distance between the individual workpieces can be adjusted,
wherein a distance between longitudinal axes of single workpieces essentially corresponds to a circumference of a workpiece.
